(19) United States
(12) Patent Application Publication
(10) Pub. No.: US 2026/0146437 A1
(43) Pub. Date: May 28, 2026

(54) BUILDING FRAME BRACING

(71) Applicant: Illinois Tool Works Inc., Glenview, IL (US)

(72) Inventor: Bernard Joseph KENNELLY, Sydney (AU)

(21) Appl. No.: 19/395,564

(22) Filed: Nov. 20, 2025

(30) Foreign Application Priority Data
Nov. 26, 2024 (AU) 2024266913

(51) Int. Cl. E04B 1/26

(52) U.S. Cl. CPC E04B 1/2604; E04B 2001/2644

(57) ABSTRACT

A brace adapted to be fixed to members of a building frame in an orientation. The brace comprises a strip that can be received against members of the frame to assume a said orientation.

### PRIORITY CLAIM

This application claims priority to and the benefit of Australian Patent Application No. 2024266913, filed Nov. 26, 2024, the entire contents of which are incorporated herein by reference.

### TECHNICAL FIELD

The present disclosure relates to bracing of building frames, especially but not necessarily solely such frames which comprise timber frame members, including in particular wall, roof, and floor frames.

### BACKGROUND

Timber framing is often employed in building construction, particularly in the construction of houses. Such framing typically comprises wall frames and roof frames and may include floor frames (particularly where the building has two or more storeys). Wall frames generally comprise parallel spaced apart upright members or posts, known as “studs”, pieces connected between adjacent ones of the studs, known individually as “nogs” or “noggins (and collectively as “nogging”), and elongate horizontal “bottom plate” and “top plate” members defining lower and upper edges of the frame securable, respectively, to structure (typically a foundation or floor framework) on which the wall frame is to be supported and to structure (typically roof framework) which is to be supported by the wall frame. Roof frames generally include prefabricated trusses and/or rafters, which comprise parallel spaced apart members, and members extending perpendicular thereto and interconnecting them, typically comprising “battens” and/or “purlins.” Floor frames typically comprise parallel spaced apart horizontal members, known as “joists,” and elongate members extending perpendicular thereto and interconnecting them, typically comprising “bearers” and/or “girders,” and may include pieces connected between adjacent ones of the joists, known collectively as “blocking.”

Building framework, including wall, roof and floor frames, must be braced throughout, in particular so as to be able to resist horizontal forces on the building (racking forces). A common form of bracing comprises steel strapping, provided at either or each of opposed faces of the frame and extending diagonally relative to the parallel spaced apart members therein, which strapping is fastened, typically nailed, to the frame.

Strapping is particularly suitable in applications where space restrictions preclude the provision of thick bracing, e.g. comprising timber braces, and/or where it is necessary to bend the bracing to be able to fix it to surfaces in different planes within the framework.

Bracing of building framework, including by way of strapping, is governed and guided by codes and standards, including (in Australia) AS 1684-2010 Residential timber-framed construction and AS4440:2004 Installation of Nailplated timber trusses, which stipulate criteria/set out guidelines for the provision of bracing (particularly for wall frames and roof frames respectively), the contents of both of which are incorporated herein by reference.

It is desirable that bracing be easily and economically installable, including such that handling of excessively long sections thereof and/or splicing of insufficiently long sections thereof, is eliminated, and in a manner such that it complies with the relevant codes/standards, and readily checkable for compliance once installed.

### SUMMARY

In a first aspect, the present disclosure provides a brace adapted to be fixed to members of a building frame in an orientation, the brace comprising a strip which can be received against members of the frame to assume a said orientation.

The brace may be formed therealong with formations for receipt of driven fasteners therethrough to fix the brace to said members. At least one said formation may be configured such that a tip of a said fastener is receivable thereby at a discrete position.

In some embodiments, the brace may be an angled cross-sectional configuration conferring rigidity thereto. The brace may comprise at least one wall portion that is laterally inclined whereby the brace has said angled cross-sectional configuration. The brace may comprise opposed, laterally inclined side wall portions each of which defines a respective said wall portion that is laterally inclined.

A central wall portion may be provided between said inclined side wall portions. The formations may be positioned in a staggered arrangement along a length of the central wall portion. The central wall portion may be configured to abut, at positions therealong, surfaces of members against which it is received whereby it is braced by the surfaces against deformation when driven fasteners are applied therethough at said positions to fix the brace to the members.

In some embodiments, the brace may be configured at either or each of opposite ends thereof with one or more connecting members so as to be end-to-end couplable to a like brace. The brace may be configured at opposite ends thereof with connecting members so as to be end-to-end couplable with a like brace at each of the opposite ends. The connecting member(s) at the or each end of the brace may comprise projecting tab(s) that project outwardly from the strip.

In a second aspect, the present disclosure provides a method of fixing a brace according to the first aspect to a said building frame, wherein the brace is positioned in a said diagonal orientation whereby the orientation is established, the method including fixing the brace to at least one said member in the orientation so established.

The method may comprise fixing the brace to the at least one said member comprises driving into said member(s) fasteners received through formation(s) provided within the brace.

In some embodiments, the method may further comprise selecting ones of braces having appropriate individual length to arrive at, or at least near, a desired overall length.

In a third aspect, the present disclosure provides a coupler that is configured to join together a pair of like braces according to the first aspect, wherein the coupler is provided with a plurality of connecting elements configured to engage the respective braces.

In some embodiments, the connecting elements may be configured to engage connecting member(s) of the respective braces. In particular, the connecting elements may be configured to receive projecting tab(s) of the respective braces.

In a fourth aspect, the present disclosure provides a brace assembly comprising a pair of braces according to the first aspect and a coupler according to the third aspect, with the pair of braces being joined together by and engaged with the coupler.

In a fifth aspect, there is provided a kit for forming the brace assembly according to the fourth aspect, the kit comprising a coupler according to the third aspect and a plurality of braces according the first aspect.

The plurality of braces may include braces provided in different lengths, to thereby enable the kit to form a brace assembly to match a required span by selecting braces of appropriate length.

In a sixth aspect, the present disclosure provides a method of bracing a building framework, comprising the steps of: coupling respective braces together in an end-to-end manner to form a brace assembly configured to span between first and second members of the building framework; fixing a first brace to the first member of the building framework; and fixing a second brace of the brace assembly to the second member of the building framework.

Optionally, the coupling step may precede at least one of the fixing steps.

Disclosed generally herein is a brace adapted to be fixed to members of a building frame in an orientation, the brace comprising a strip which can be received against members of the frame to assume a said orientation.

Said orientation may comprise a diagonal orientation.

The brace may be formed therealong with holes and/or precursors therefor for receipt of driven fasteners, preferably comprising nails, therethrough to fix the brace to said members.

The brace may comprise therealong one or more formations in and/or on a surface/face thereof arranged to face away from the member against which the strip is received for receipt of driven fasteners, preferably comprising nails, therethrough to fix the brace to said members. The formations may define said holes and/or precursors therefor.

At least one said formation or precursor may comprise a cavity in the surface and/or is impressed in or into said surface, such that it can receive a tip of a said fastener whereby the fastener can be driven through the strip/strap.

At least one said formation or precursor or cavity may be elongate, e.g. comprises a channel or groove, such that it can receive a tip of a said fastener at any position therealong. At least one elongate formation may extend lengthways and/or widthways.

At least one said formation or precursor may be configured—e.g. in the form of a dimple or crater—such that a tip of a said fastener is receivable thereby at a discrete position.

At least one said formation or precursor may comprise a rough or roughened—e.g. abraded—surface region whereby a tip of a said fastener received by that formation or precursor is precluded from slipping or sliding relative to the formation or precursor—e.g. along a said channel, groove or elongate formation which that formation or precursor comprises.

Said formations or precursors and/or holes may comprise ones arranged or extending along widthways spaced lines.

Said hole(s) or precursor(s) and/or formation(s) may be arranged such that the fastener(s) penetrate respective widthways-centred portions of the member(s) having widths not exceeding a third of the width of the respective member.

The brace may be configured at either or each of opposite ends thereof with one or more connectors so as to be end to end interconnectable with a like brace.

The brace may be configured at opposite ends thereof with connectors so as to be end to end interconnectable with a like brace at each of the opposite ends.

The brace may have an angled cross sectional configuration conferring rigidity thereto.

The brace may comprise at least one wall portion which is laterally inclined whereby the brace has said angled cross sectional configuration.

The brace may comprise opposed, laterally inwardly inclined side wall portions each of which defines a respective said wall portion that is laterally inclined.

The brace may comprise a central wall portion between said inclined side wall portions.

The brace may be configured to abut, at positions therealong, surfaces of members against which it is received whereby it is braced by the surfaces against deformation when driven fasteners are applied therethough at said positions to fix the brace to the members.

The brace may comprise at least one wall portion in(to) and along which are formed one or more impressions arranged to abut surfaces of members against which the brace is received, whereby the brace is braced by the surfaces against deformation when driven fasteners are applied through the impressions at said positions to fix the brace to the members.

The at least one wall portion in and along which are formed one or more impressions may comprise one or more said laterally inclined wall portions.

The one or more impressions comprise dimples or craters may be arranged to abut said surfaces whereby the brace is braced against said deformation when driven fasteners are applied through bottoms of the dimples or craters.

The one or more impressions may comprise at least one groove or channel, having a base, arranged to abut said surfaces whereby the brace is braced against said deformation when driven fasteners are applied through the base(s).

The one or more impressions may comprise the holes and/or one or more precursors.

In accordance with some embodiments of the present disclosure, the one or more impressions may comprise the one or more formations.

The brace may be configured at a first end of the opposite ends thereof with one or more connectors each comprising a tab, and at the other end of the opposite ends thereof with one or more connectors each comprising a hole for receiving a respective one of the tab(s) of a like brace when said brace and the like brace are end to end interconnected.

The building frame may be a wall frame. Preferably said members of the wall frame comprise studs.

The building frame may be a roof frame, which may, for example, comprise a roof truss. Preferably said members of the roof frame comprise chords and or rafters.

The building frame may be a floor frame. Preferably, said members of the floor frame comprise joists.

Preferably, said members of the building frame are of timber material.

Also disclosed generally herein is a method of fixing a said brace to a said building frame, wherein the brace is positioned whereby the orientation is established, the method including fixing the brace to said members in the orientation so established.

Also described generally herein is formed an assembly comprising two or more end-to-end interconnected braces, the method comprising selecting ones of braces having appropriate individual length to arrive at, or at least near, a desired overall length of the interconnected braces.

Preferably, fixing the brace to said members comprises driving into said members fasteners received through ones of said hole(s) and/or formation(s) or precursor(s).

In the description in this specification, reference may be made to subject matter which is not within the scope of the appended claims. That subject matter should be readily identifiable by a person skilled in the art and may assist in putting into practice the present disclosure as defined in the presently appended claims.

### DESCRIPTION OF THE SEVERAL VIEWS OF THE FIGURES

The present disclosure will now be described, by way of non-limiting example, with reference to the accompanying drawings.

FIG. 1A is a schematic perspective view showing two like braces according to a first preferred embodiment of the present disclosure, each brace having side wall portions, and impressions in the form of dimples or craters formed into each of the side wall portions at respective positions therealong.

FIG. 1B is a schematic perspective view of opposed ends of braces according to the first preferred embodiment, the end of one of the braces being configured to be connected to the end of the other of the braces such that there is formed a brace assembly comprising the interconnected braces.

FIG. 1C is a schematic perspective view showing interconnected ends of braces according to the first preferred embodiment in a said brace assembly.

FIG. 1D is a schematic view (e.g. an end or cross-sectional view) showing a cross-sectional configuration of an existing/known brace and a brace according to the first preferred embodiment.

FIG. 2A is a first schematic perspective view of an end portion of a brace according to a second preferred embodiment of the present disclosure, the brace being the same as that of the first embodiment, having side wall portions and impressions in the form of dimples or craters formed into each of the side wall portions at respective positions therealong, with the exception that the said end thereof is not configured to be connected to an end of a like brace.

FIG. 2B is a second schematic perspective view of a lengthways section or portion of a brace according to the second preferred embodiment.

FIG. 2C is a third schematic perspective view a lengthways section or portion of a brace according to the second preferred embodiment.

FIG. 3A is a first schematic (lower/inner side) perspective view of a lengthways section or portion of a brace according to a third preferred embodiment of the present disclosure, the brace having sidewall portions and impressions formed in and along the sidewall portions that comprise grooves or channels.

FIG. 3B is a second schematic (upper/outer side) perspective view of a lengthways section or portion of the brace according to the third preferred embodiment of the present disclosure.

FIG. 4 is a schematic (upper/outer) perspective view of a brace according to a fourth preferred embodiment of the present disclosure, the brace having sidewall portions and impressions formed in and along the sidewall portions that comprise channels, and score lines or ridges formed in or on the channel interior surfaces to preclude slippage.

FIG. 5A is a schematic perspective view of a brace according to a fifth preferred embodiment of the present disclosure, the brace having a central portion that has receiving formations formed therein and is flanked by sidewall portions that comprise upwardly extending curb portions.

FIG. 5B is a schematic end view of the brace according to the fifth preferred embodiment, the brace having an M-shaped profile.

FIG. 5C is a schematic top view of the brace according to the fifth preferred embodiment of the present disclosure, the brace having end sections that comprise connecting members that are provided to assist in joining the brace with a further like brace.

FIG. 5D is an enlarged upper perspective view of the encircled region A of FIG. 5B, the connecting members projecting upwardly from the central portion.

FIG. 5E is an enlarged lower perspective view of the detail A of FIG. 5B, the connecting members being formed from the central portion.

FIG. 6A is a schematic perspective view of a coupler according to a sixth preferred embodiment of the present disclosure, the coupler being configured to interconnect two braces provided in accordance with the fifth preferred embodiment.

FIG. 6B is a schematic top view of the coupler according to the sixth preferred embodiment of the present disclosure, the connector having connecting elements that are configured to interlock with the connecting members of a brace provided in accordance with the fifth preferred embodiment.

FIG. 6C is a schematic end view of the coupler according to the sixth preferred embodiment, the coupler having an M-shaped profile and a pair of locating spades the project downwardly therefrom.

FIG. 7A is a schematic upper perspective view of a brace assembly in accordance with a seventh preferred embodiment of the present disclosure, the brace assembly comprising a pair of braces provided in accordance with the fifth preferred embodiment that are fixed together in an end-to-end arrangement by a coupler provided in accordance with the sixth embodiment.

FIG. 7B is an enlarged upper perspective view of the detail B of FIG. 7A, with respective connecting members of the braces interlocking with the connecting features of the coupler.

FIG. 7C is an enlarged lower perspective view of detail B of FIG. 7A, the braces being spaced apart by downwardly projecting locating spades of the coupler.

FIG. 7D is a schematic perspective section view along the line A-A in FIG. 7B; with the respective connecting members of the braces interlocking with the connecting features of the coupler.

FIG. 7E is a schematic section view along the line A-A in FIG. 7B, showing the connecting features of the coupler (without the braces).

FIG. 7F is a further schematic section view along the line A-A in FIG. 7B, showing the connecting features of the braces (without the coupler).

FIG. 7G is a further schematic section view along the line A-A in FIG. 7B, showing the respective connecting members of the braces interlocking with the connecting features of the coupler, the connecting members having a first (theoretical) profile according to an embodiment of the present disclosure.

FIG. 7H is a further schematic section view along the line A-A in FIG. 7B, showing the respective connecting members of the braces interlocking with the connecting features of the coupler, the connecting members having a second profile according to an embodiment of the present disclosure.

FIG. 7I is a schematic section view of detail C in FIG. 7H, showing a nose portion of the coupler configured to engage a connecting member of the one of the braces when the brace assembly is tensioned throughout its length.

FIG. 8A is a schematic upper perspective view of a brace assembly in accordance with an eighth preferred embodiment of the present disclosure, the brace assembly comprising a pair of braces provided in accordance with the fifth preferred embodiment that are fixed together in an end-to-end arrangement by a plurality of screws.

FIG. 8B is a schematic lower perspective view of the brace assemble according to the eight preferred embodiment.

FIG. 9A is a schematic upper perspective view of a brace assembly in accordance with a ninth preferred embodiment of the present disclosure, the brace assembly comprising a pair of braces provided in accordance with the fifth preferred embodiment that are fixed together in an end-to-end arrangement by a plurality of rivets.

FIG. 9B is a schematic lower perspective view of the brace assemble according to the ninth preferred embodiment.

FIG. 10 is a flowchart schematically illustrating a method of bracing a timber building frame in accordance with a further preferred embodiment of the present disclosure.

### DETAILED DESCRIPTION

While the systems, devices, and methods described herein may be embodied in various forms, the drawings show, and the specification describes certain exemplary and non-limiting embodiments. Not all components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

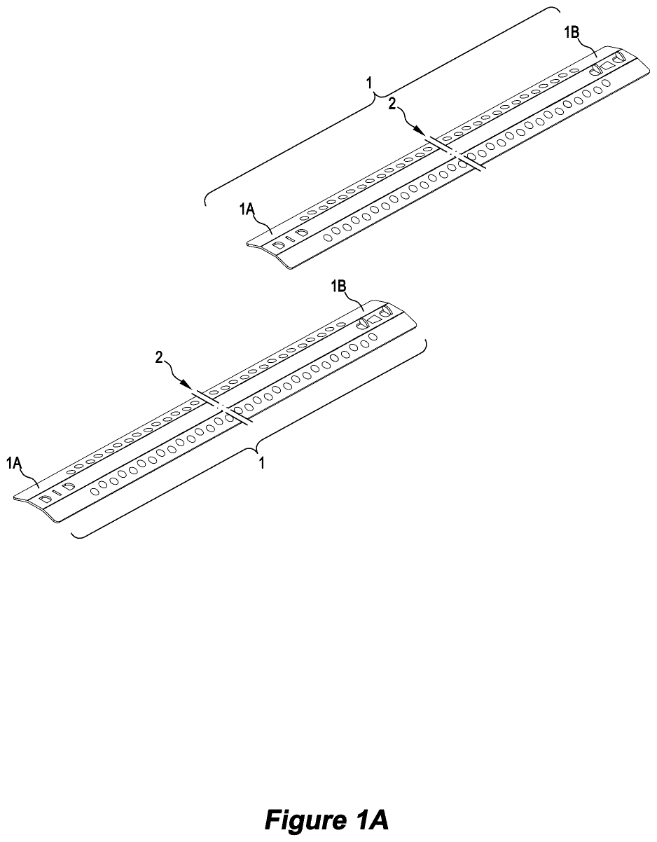

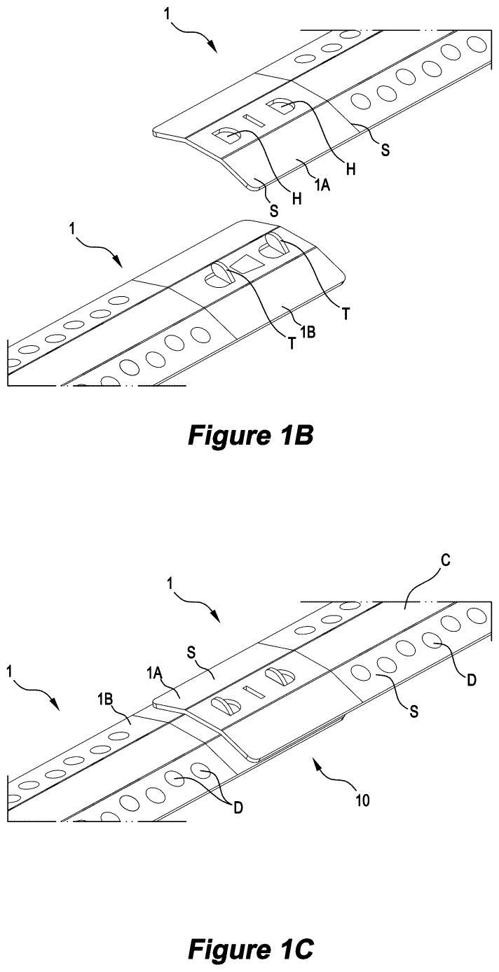

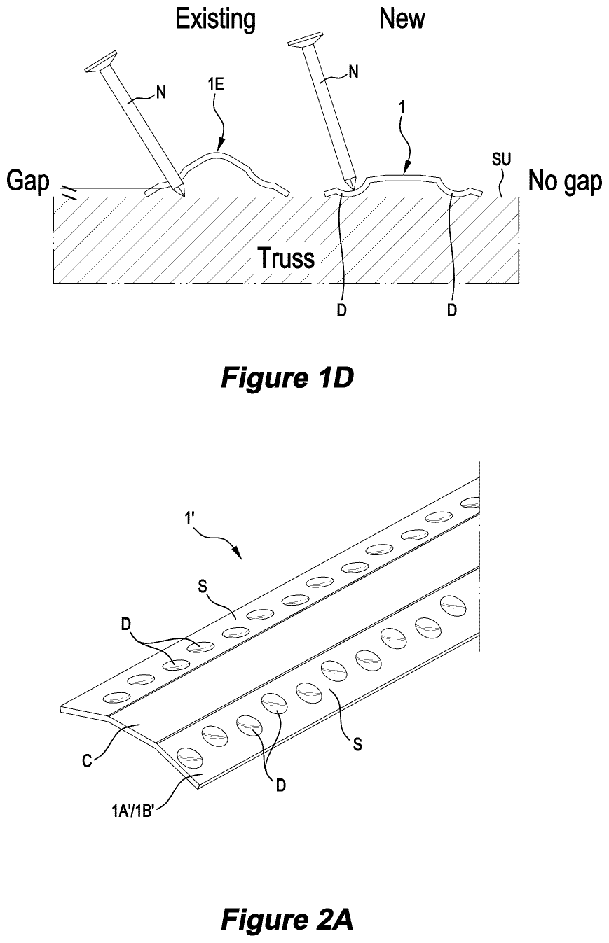

Shown in FIGS. 1A-1D are details of a brace 1 according to a first preferred embodiment of the present disclosure. The brace 1 has opposed ends 1A and 1B configured to be connectable with ends 1B and 1A respectively of a like brace 1, so as to form a brace assembly 10 comprising two or more end-to-end interconnected braces 1.

Brace 1 is produced and supplied in specific lengths, including lengths of 3.6 m and 4.2 m (being same as for walls). FIG. 1A shows two braces 1, each brace 1 being shown with a schematic break/discontinuity 2 intermediate a length thereof for clarity only (to fit the braces 1 on the same page), it being understood each example brace 1 is a longitudinally extending/elongate, preferably straight, unitary/continuous member.

The brace 1 is formed from a strip and has opposed lateral side wall portions S, which are laterally inwardly inclined, and a central wall portion C between the portions S. The resulting angled cross-sectional configuration confers rigidity.

End 1A comprises one or more connectors comprising respective tabs T which are punched/formed from the strip whereby they project diagonally—upwardly and in a direction towards the opposite end 1B—from the wall portion C. End 1B comprises one or more (complementary) connectors comprising respective recesses/holes H punched or stamped in the strip, each being positioned to receive a respective one of the tabs T whereby the ends 1A and 1B of the straps 1 are interlocked such that the brace assembly 10, comprising axially aligned end-to-end interconnected braces 1, can be tensioned throughout its length.

The interlockable ends 1A and 1B of the braces 1 advantageously facilitate the efficient, and in particular easy, rapid and reliable, formation of the brace assembly 10 having end-to-end interconnected braces 1 without requiring nailing of one of the braces relative to the other braces and/or splicing the braces 1 over the building framework to interconnect the braces and thereby form an assembly 10 (comprising two or more end-to-end interconnected braces 1, as discussed further below). Further, by selecting interconnectable braces 1 of suitable length, from a brace system comprising braces 1 provided in differing standard lengths in accordance with a preferred embodiment of the present disclosure, it may be possible to reduce or avoid wastage otherwise resulting from the brace assembly being longer than necessary.

Formed into each of the wall portions S at respective positions therealong, between the end sections 1A and 1B, are formations, comprising impressions or cavities which in the present embodiment are in the form of dimples or craters D. FIG. 1D shows the cross-sectional configuration or profile of the strap 1, or of either of straps 1′and 1″ (each of which is discussed further below), together with that of an existing/known brace 1E. The dimples D are arranged such that, when the brace 1 is received against a surface SU within the timber framework to which it is to be applied, such as a surface of a truss (and/or possibly a stud wall frame) within the timber framework, they abut that surface. Each of the dimples D is arranged to receive a tip of a respective fastener, such as a nail N, at the (respective) discrete position at/towards which the dimple/crater converges (that position coinciding with a base of the formation, impression or cavity, which base is received against the member surface), whereby the fastener can be driven through the strip/strap 1. Advantageously, owing to there being no gap between the base/dimple D and the surface SU, nail N can be driven through the bottom of the dimple D using a nail driving tool (since the dimple D/side wall S/brace 1 is braced by that surface against deformation during driving). The nails N can thus be applied rapidly, with negligible change to the strap profile.

An example method of fixing two or more of the braces 1 to a building frame, wherein the braces are positioned in a diagonal orientation and interconnected, thereby forming a braces assembly 10, comprises positioning a first of the braces 1 in a diagonal orientation. The first brace 1 is then fixed/nailed, such as at or near a first end 1A/1B of the brace 1, to a member of framework, such as a truss/roof truss, of the building frame. A second brace 1 can then be hooked or clipped on to (end-to-end connected to/interlocked with) the first brace and pulled from the other end of the of the second brace to straighten and tension the brace assembly 10 formed thereby before fixing the second brace 1/the said other end thereof to a or the member of the framework. It will be understood the brace assembly 10 may comprise more than two, e.g. three or more, axially aligned interlocked braces 1 depending on the overall desired length of the assembly. The interconnected braces 1 can then be fastened/nailed (by a fastener driving tool) to one or more said members, comprising in particular one(s) intermediate the ends of the tensioned braces 1/assembly 10, along the length of the braces 1/assembly 10 to fix the braces/assembly thereto.

Advantageously, by selecting ones of braces 1 having appropriate individual lengths, it may be possible to arrive at, or at least near, a desired overall length of the interconnected braces 1/brace assembly 10. Alternatively, if a brace 1, such as the last-positioned brace 1, needs to be trimmed/cut to reduce the length of the brace whereby the desired length is attained, the offcut portion of the brace 1, which portion in and of itself defines a brace embodying the present disclosure (in which one of the two ends comprises said connector(s)), could be used at the start of the next run.

Further, advantageously the brace assembly 10, formed by two or more (shorter) braces 1, having lengths less than the desired length of the assembly, and/or the rounded edges of the example brace 1, facilitate the safe and efficient installation/fixing of the braces to a framework of a building frame, particularly when working at height.

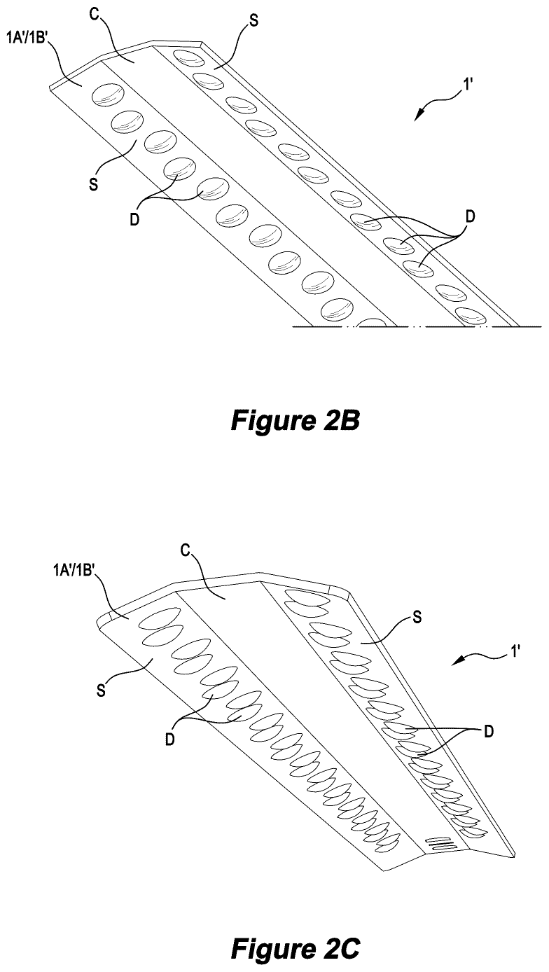

Shown in FIGS. 2A-2C are details of a brace 1′ according to a second preferred embodiment of the present disclosure. The brace 1′ is substantially identical to the brace 1′ except that either or each of the opposed end sections 1A′/1B′ has no complementary connectors/connector formations, such as the tabs T and recesses/holes H of the brace 1, for axially aligned end-to-end interconnection of like braces 1′. The person skilled in the relevant art will understand the braces 1′, and similarly the braces 1′ and 1″ discussed below, may, instead of being end-to-end interconnected as discussed above (such as whereby a tab T is received in a respective recess/hole H), alternatively be spliced one-to-another to from a brace assembly with two or more axially aligned braces 1′.

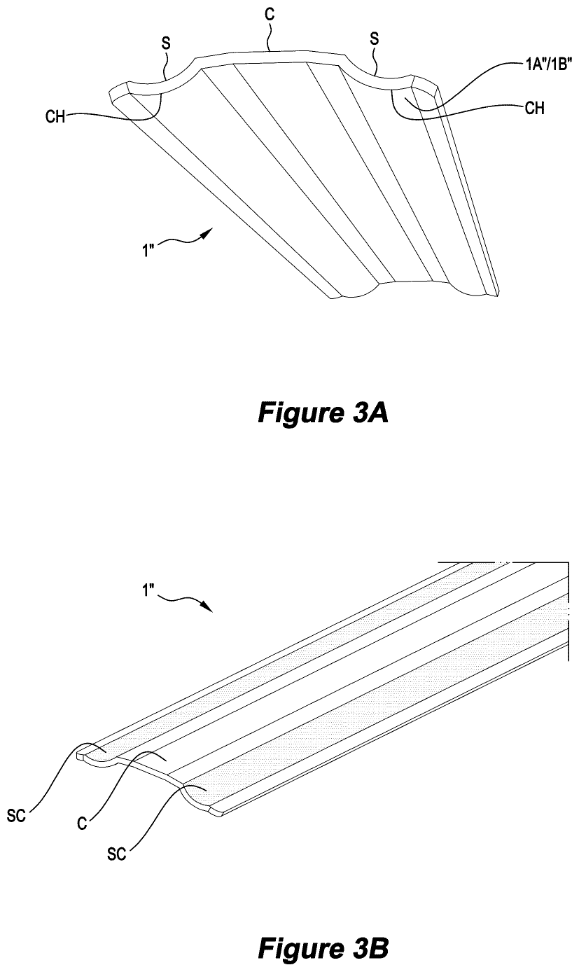

Shown in FIGS. 3A and 3B are details of a brace 1″ according to a third preferred embodiment of the present disclosure. The brace 1″ has opposed end sections, 1A″ and 1B″, either or each of which may comprise said complementary connectors/connector formations (not shown in FIGS. 3A and 3B), for instance comprising tabs T and recesses/holes H. Regardless, the impressions formed in and along the sidewall portions S in this embodiment comprise elongate grooves or channels CH, which are arranged likewise to abut the surface SU as shown at FIG. 1D. A nail N can thus similarly be driven by a nail driving tool through the base of the channel CH. Advantageously, owing to the impressions'being continuous along the length, driving of a nail N can be at any suitable/desirable position therealong (the position being selectable from a continuum, rather than from discrete positions, along the brace, and coinciding the base of the formation, impression or cavity (which in the case of the present embodiment comprises or defines a groove/channel (rather than the crater/dimple as described above)—being received against the member surface). The surfaces SC within the channels CH, shaded blue in FIG. 3B, may be roughened—e.g. via abrasion or otherwise treated—and/or be defined by an anti-slip coating or film applied within the channels—to reduce or eliminate the tendency of a nail tip or nail driving tool end received against the surface from slipping therealong.

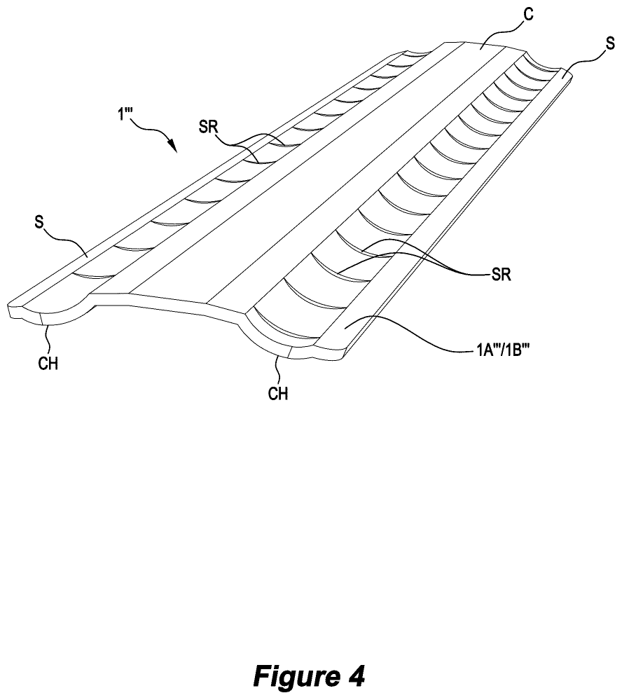

Shown in FIG. 4 are details of a brace 1′″ according to a fourth preferred embodiment of the present disclosure. The brace 1′″ also has opposed end sections 1A″′ and 1B″′, which may be the same as the end sections 1A/1B of the strap 1 comprising complementary connectors/connector formations (not shown in FIG. 4), and the impressions formed in and along the sidewall portions S may again comprise channels CH. However, the surface configuration provided to preclude slippage in this embodiment comprises (either in addition or as an alternative to that described above in respect of the previous embodiment) score lines or ridges SR formed in or on the channel interior surface.

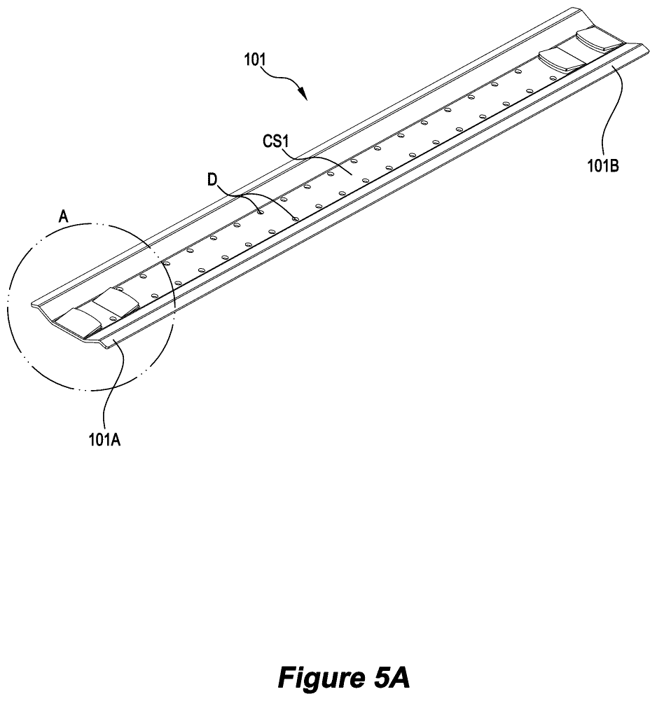

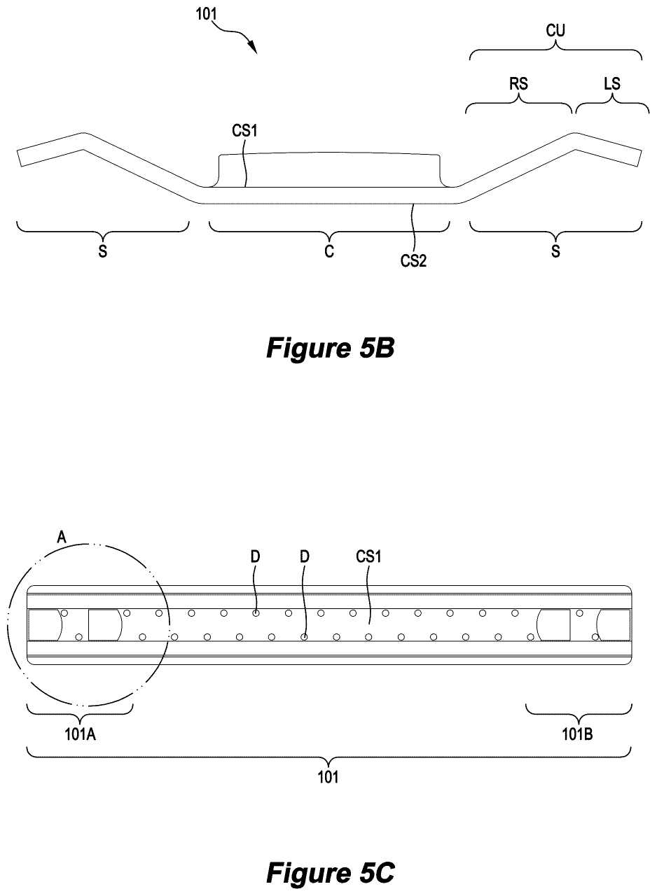

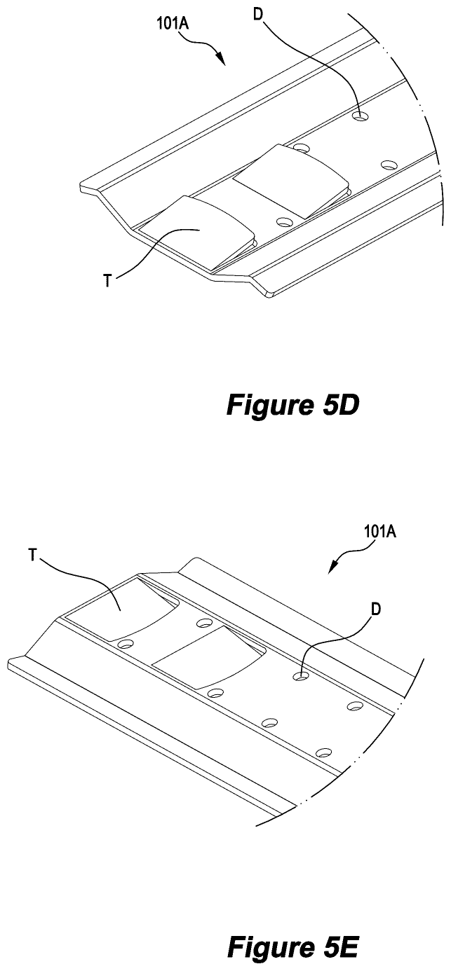

A further embodiment of the present disclosure, in the form of brace 101, will now be described with reference to FIGS. 5A to 5E. For clarity, similar reference numerals will be used to described similar features and/or functional analogues.

The brace 101 is formed as a strip that comprises a substantially flat central wall or web portion C that extends between opposed lateral side wall or flange portions S. As shown, the side or wing portions S comprise an outwardly inclined ramp surface/wall RS and an inwardly inclined landing surface LS/wall that together form a curb portion CU having an inverted V shape. The resulting generally M-shaped cross-sectional configuration/profile confers rigidity to the brace 101 which may prevent or substantially reduce sagging when carrying, thereby improving the handleability thereof. Further, the M-shaped cross-section/profile allows for the central portion C to be rested in abutment against a support surface SU (shown schematically in FIG. 1D) within the timber framework to which the brace 101 is to be applied—without the need for manual flattening. For example, the central portion C defines an (upper as shown in FIG. 5A) surface CS1 that may sit flat against a top chord or other member of which the brace 101 is applied, and an opposed (lower in FIG. 5B) surface CS2 that may face way from the top chord or other member of which the brace 101 is applied. In particular, and by way of non-limiting example only, as shown, the ramp surfaces RS may be inclined at an angle of 140-170 degrees, more particularly about 150-160 degrees, more particularly about 155 degrees with respect to the central portion, while the landing surface LS may be inclined at an angle of about 120-170 degrees, more particularly about 130-160 degrees, more particularly about 140-150 degrees, more particularly 145 degrees with respect to the ramp surface RS. The surface SU may, for example, be a surface of a truss (and/or possibly a stud wall frame, and/or other member of a building frame) within the timber framework.

Fastener receiving formations D are formed in the central wall portion C at respective positions therealong. The receiving formations D are arranged to receive and/or locate a tip of a respective fastener, such as a nail N, at the (respective) discrete positions along the strip 101. The receiving formations D are arranged such that, when the brace 101 is received against the surface SU within the timber framework to which it is to be applied, the central wall portion C abuts the surface SU, such that fasteners can be driven through the respective formations D to thereby fix the strip 101 to an underlying surface SU. For example, product nails may be hammered by hand through the formations D or a nail driving tool or other power tool such as a positive placement nailer (PPN) may be used. When used with roof truss members, the central wall portion C may have a width selected/predetermined so as to provide room to locate the receiving formations D on the underlying timber support member SU.

Advantageously, owing to there being no gap between the central wall portion C and the surface SU, nails N can be driven quickly and efficiently through the receiving formations D using a nail driving tool or hammer without causing change to the strap profile (since central portion C of the brace 101 is braced by the support surface SU against deformation during driving). As shown, the receiving formations are arranged in a staggered pattern and provided in the form of through holes or apertures that otherwise extend completely through the strip however it is understood that, in other embodiments, the formations D may be arranged differently and/or be provided in the form of blind impressions, cavities or dimples that do not extend completely through the strip.

It is also contemplated that the strip 101 may be installed in an inverted orientation to that shown in the Figures, resulting in a W-shaped cross-sectional profile or configuration. When installed in this way, it is understood that the vertex between the ramp surface RS and the landing surface LS will rest or otherwise be received against the underlying support surface LS—such that the strip 101 may still lie flat, or at least substantially flat, against the support surface LS without the need for manual flattening. In such applications, nails N may be driven through the side portions S—for example through the ramp surfaces RS—preferably by way of power tools such as a nail driving tool. Although not shown, it is contemplated that receiving formations D may also be provided within or on one or both of the side portions S—for example within or on the ramp surfaces RS and/or the landing surfaces LS.

Best shown in FIGS. 5D and 5E, the strip 101 is preferably provided with end sections 101A, 101B at opposing ends thereof. At least one, preferably each/both, of the end sections 101A, 101B comprise one or more connecting members in the form of tabs T, or other formations or projections. As shown, the projections are provided in the form of steps, which project diagonally—upwardly and in a direction towards the respective opposite end section. Preferably, the steps are formed via a swaging or stamping process, such that the strip 101 maintains a substantially constant cross-sectional area (and therefore strength) along its length. It is understood, however, that the tabs T may be shaped and/or formed differently. The respective end sections 101A, 101B are configured to engage and interlock with a coupler 112 that is used to couple the brace 101 with a further brace 101′.

The example end sections 101A, 101B each comprise two or more tabs T that are longitudinally spaced apart along a longitudinal axis of the strip 101. Alternatively or additionally, the end sections 101A, 101B may comprise two or more tabs T that are laterally spaced apart (not shown).

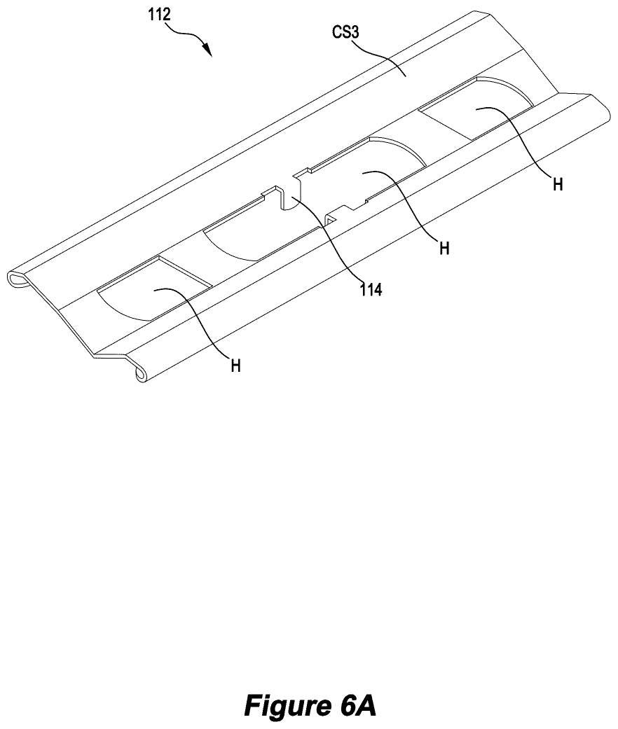

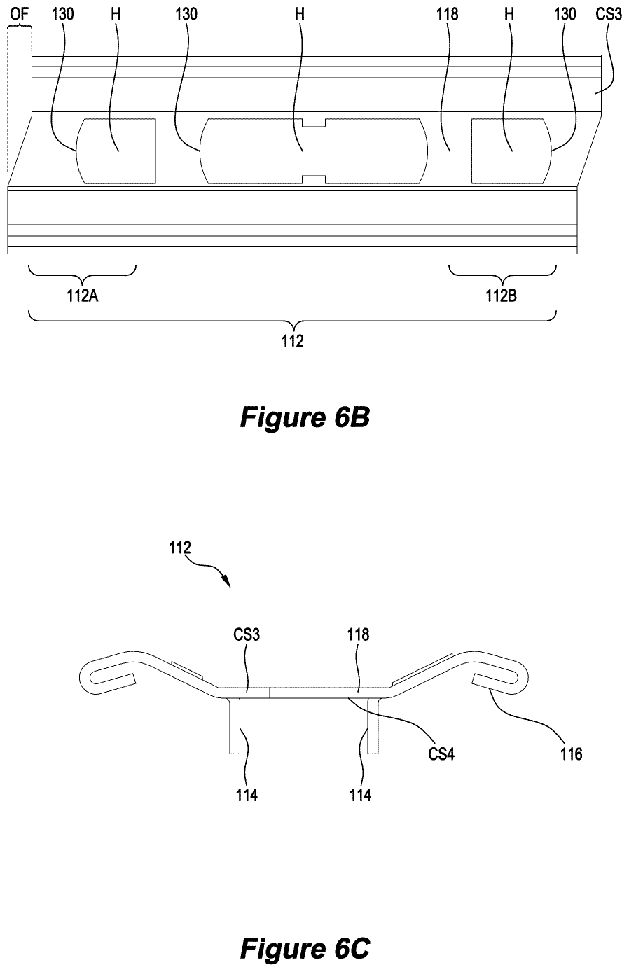

As shown in FIGS. 6A to 6C, the coupler 112 is provided in the form of an elongate strip or sleeve. The example coupler 112 is a unitary part/body comprising a central portion 118, such as a wall or web, opposed side wall or flange portions 102, and opposed hook or clip portions 116. The central portion 118 defines a (lower in FIG. 6C) surface CS4 configured to face away from the surface CS1 of the brace 101 when the coupler is used to interlock together the brace 101 to a like brace 101′, and an opposed (upper as shown in FIG. 6A) surface CS4 configured to sit flat against the upper surface CS2 of the brace 101. The width of the central portion 118 substantially corresponds to the width of the central portion C of the braces. The central portion 118 extends longitudinally between side wall portions 102, which each have a profile that substantially matches the profile(s) of the side wall portions S of the brace 101. The side wall portions 102 extend longitudinally between central portion 118 and the laterally arranged hook portions 116 provided on opposite sides of the central portion 118. The hook portions 116 define longitudinally extending apertures configured to receive laterally opposed edges of and to engage the side portions S of the braces 101. The hook portions 116 are configured to retain the coupler 112 relative to a brace 101 when the coupler 112 is used to interconnect braces (discussed below).

The coupler 112 further comprises connecting elements in the form of respective pockets/recesses/apertures/holes H that are punched or otherwise formed in the central portion 118, each being positioned and having a complementary geometry to receive a respective one of the tabs T of the end sections 101A, 101B of the brace 101. In particular, as shown, respective ends 112A, 112B of the coupler 112 are each provided with a discrete connecting element that configured to receive a corresponding connecting member of braces 101/101′. A further connecting element is provided substantially mid span of the coupler 112. This central connecting element is arranged to receive respective connecting members of each of the adjoining braces 101/101′, with the end sections thereof being spaced apart by one or more downwardly projecting spades/stops 114 which, as shown, extend from a perimeter of the central connecting element. The discrete and central connecting elements are longitudinally spaced apart along a longitudinally axis of a body of the coupler 112. Alternatively or additionally, the connecting ends 112A, 112B of the coupler 112 may each be provided with plurality of longitudinally, or laterally, spaced apart discrete connecting elements that are each configured to receive a corresponding connecting member of braces 101/101′ (not shown). Engagement of the connecting elements of the coupler 112 with the connecting members of the brace 101 provides a “click and lock” type splice/join that is particularly strong in compression, which is beneficial when assembling together a plurality of braces 101 to span a required distance of the framework. Notably, the click and lock join provided by the coupler 112 reduces a reliance on installer skill, resulting in a consistent quality of splice.

It is understood that, in other embodiments, the complementary interlocking connecting members of the braces 101 and coupler 112 may be reversed, such that the end sections 101A, 101B are provided with pockets/recesses/holes H and the coupler 112 is provided with projecting tabs or steps T. Such arrangement, whilst contemplated, is thought to be less preferred than that what is shown because it may limit or otherwise affect the ability for the central portion C of the brace 101 to abut directly against the surface SU, and may also result in a reduced strength of connection due to a lowered rigidity of the end sections 101A, 101B.

To assist in securing the coupler 112 to respective braces 101, the respective ends 112A, 112B of the coupler 112 are provided with an offset OF—put differently, the ends 112A, 112B of the coupler 112 are not cut square. Best shown in FIG. 6B, the offset OF provides a stagger, along a longitudinal axis of the body of the coupler 112, between the hollow hook portions 116 provided on opposite sides of the coupler 116, facilitating an insertion process by which the side portions S of the braces 101 may be introduced into the hollows of the hook portions 116. In particular, the offset allows a first respective side portion S of a respective brace 101 to be received within a corresponding hook portion 116 of the coupler 112 while the opposing second side portion S of that brace 101 remains outside of the coupler, allowing an installer to twist the brace 101 into alignment.

Best shown in FIG. 6C, the coupler 112 has a profile/cross-section that substantially matches the generally M-shaped cross-sectional configuration/profile of the brace 101. Notably, however, one or both of the sides of the profile are provided with hook portions 116 that form respective hollows that are arranged to substantially envelop or otherwise engage and/or receive the landing surfaces LS of the side portions S of the brace 101, said landing surfaces LS serving as rails about which the hook portions 116 are slidably engaged. In this manner, the hook portions 116 may assist in guiding the coupler 112 into axial alignment with the brace 101 and allow for the coupler 112 to be slid or otherwise moved relative to the brace 101 into position for coupling 112, with the downwardly projecting spades 114 serving as a stop to locate the brace 101 such that the connecting members thereof are aligned with the connecting elements of the coupling 112.

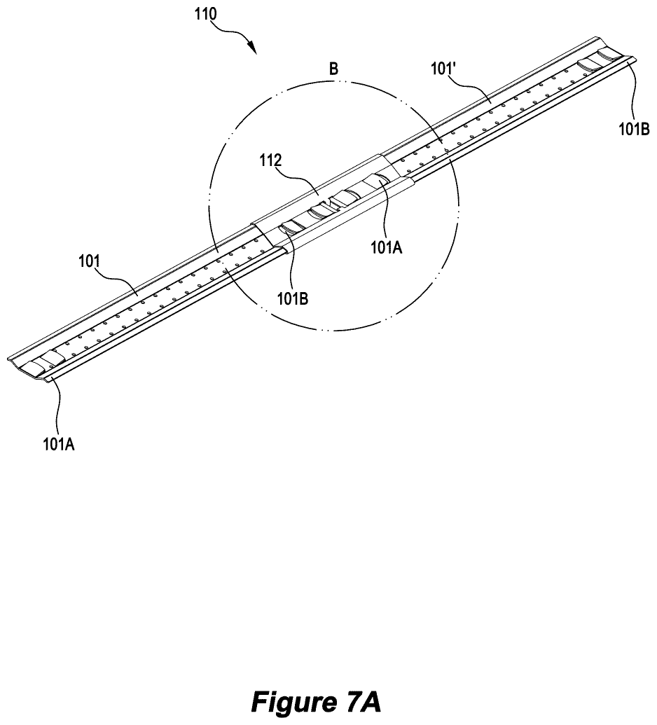

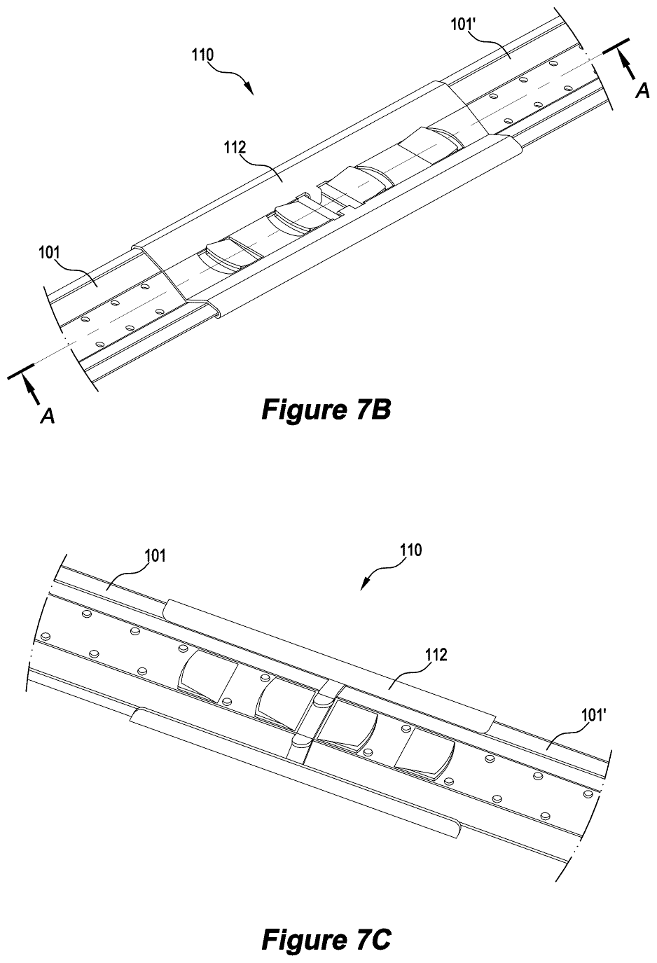

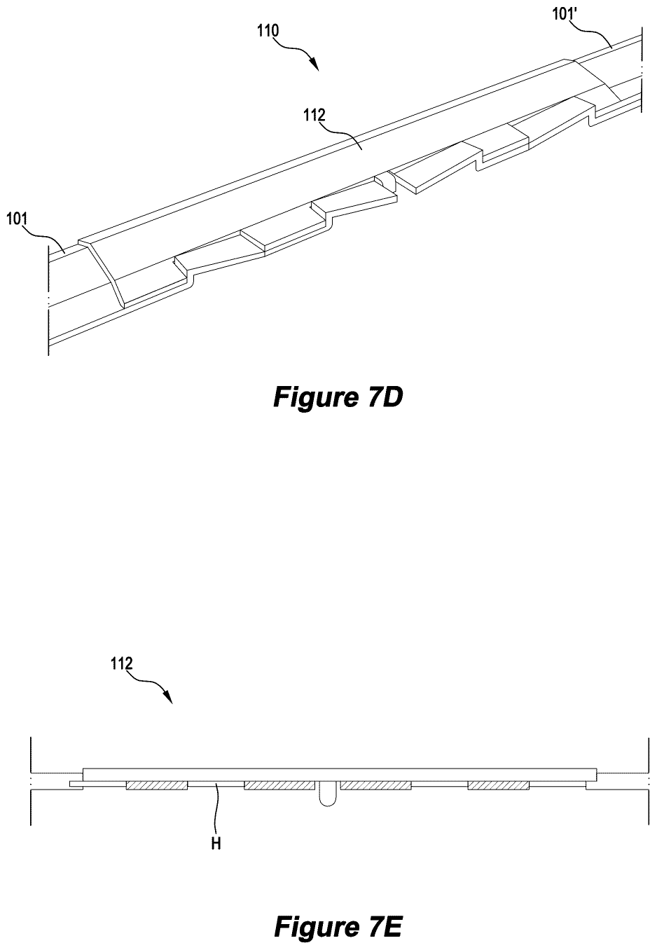

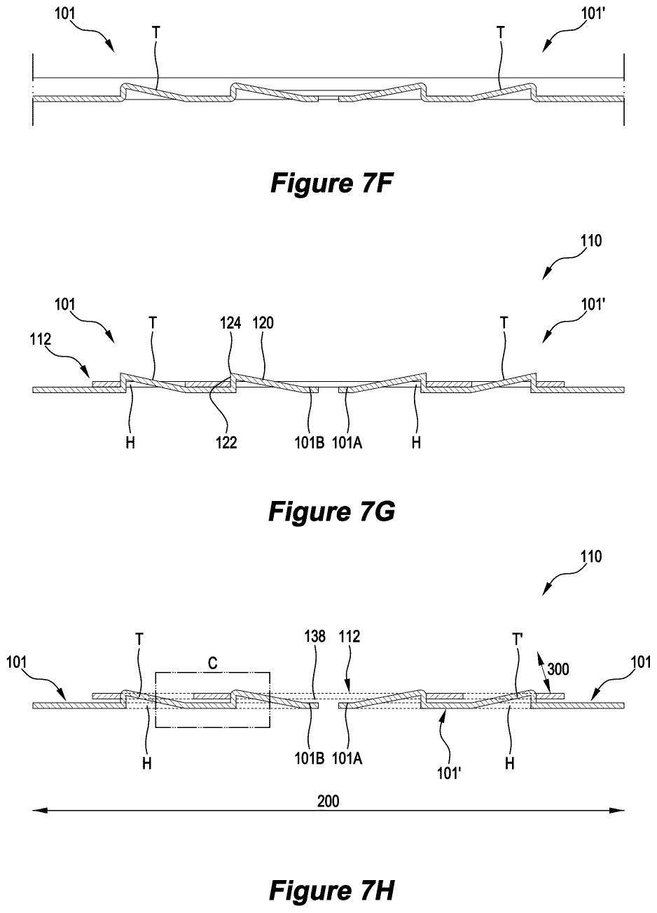

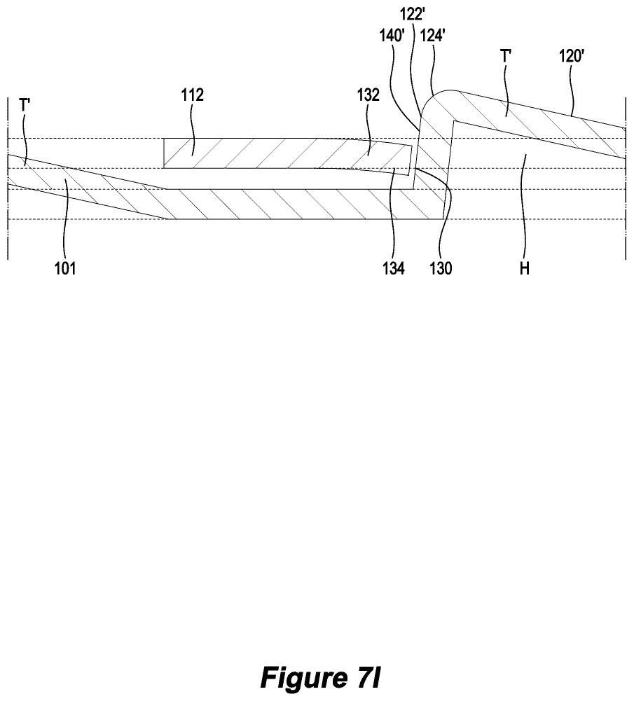

When interlocked together by a respective coupler 112, axially aligned end-to-end braces 101, 101′form a brace assembly 110 that can be tensioned throughout its length. The brace assembly is shown in FIGS. 7A to 7I. Notably, the interlocking arrangement between end sections 101A and 101B of the brace 101 and the coupler 112 advantageously facilitate an efficient, and in particular easy, rapid and reliable, formation of the brace assembly 110 having end-to-end coupled braces 101 without requiring nailing of one of the braces relative to the other braces and/or splicing the braces 101 over the building framework to couple or otherwise interconnect the braces and thereby form an assembly 110 (comprising two or more braces 101 aligned in end-to-end arrangement with respective coupler 112 positioned and extending therebetween as a bridge).

With reference to FIGS. 7G-7H, and as noted above, the tabs T of the braces 101 each project diagonally-upwardly and in a direction from the end 101B (or alternatively end 101A) proximal the tab T towards the opposite end 101A distal the tab T from the wall portion C. The tabs T of the example brace 101 thereby each define a ramp or raised portion/surface 120, for example in form of an inclined plane, which extends longitudinally and laterally, and upwardly and in a direction from the end 101A towards the opposite end 101B from the wall portion C. The tabs T each further define a laterally extending edge/corner/transition portion 124, and an end portion/surface 122 that intersects with/transitions into the ramp portion 120 at or near the edge portion/edge 122. The end portion 124 extends laterally, and downwardly from the edge portion 122/end of the ramp portion 120 towards and to the wall portion C.

With reference to FIG. 7G, according to an embodiment of the present disclosure, each of the tabs T may have a first (theoretical) profile along the longitudinal direction of the brace 101 (or 101′) that is a saw-tooth-like profile. In particular, each of the example tabs T shown in FIG. 7G comprise the ramp surface 120 that extends in an inclined plane, and the end surface 122 that extends upwardly and substantially perpendicularly (e.g. substantially vertically in the orientation of the brace assembly 110 shown in FIG. 7G) from the wall portion C, the ramp and end portions 120, 122 meeting at the laterally extending and substantially sharp (i.e. defining an angular transition substantially without any curvature) edge 124 at an intersection of the ramp surface 120 and the end surface 124.

In practice, however, it may be difficult and/or inefficient, at least in some circumstances, such as when the tabs T are punched from the strip, to form the tabs T shown in FIG. 7G that each comprise a sharp edge 124 at the intersection of the ramp and end surfaces 120, 122. Accordingly, in practice and with reference to FIGS. 7H and 7I, it may be required and/or more efficient to form/manufacture the braces 101 with projections in the form of tabs/steps T′ that each have the alternative, still substantially saw-tooth-like, profile shown in FIGS. 7H and 7I. In particular, the example tabs T′ each have a ramp portion 120′ that is substantially similar to the ramp portion 120. The tabs T have an end portion/surface 122′ that differs to the end portion 122, however, in that the end portion 122′ projects diagonally-upwardly and in a direction from the end 101A (or alternatively end 101B) distal the tab T′ towards the opposite end 101B proximal the tab T′—from the wall portion C. The tabs T′ may also be formed with a radiused/curved (that is, not sharp) edge 124′, instead of the theoretical sharp edge 124, that extends laterally across the brace in a region where the ramp potion 120′ intersects and transitions into the end portion 122′. That is, the edge may alternatively be a radiused, or rounded or curved edge, 124′.

When the coupler 112 is secured to like braces 101, 101′ to form an assembly having axially aligned end-to-end interconnected braces 101, 101′, and the assembly is tensioned throughout its length (as generally indicated by arrow 200 in FIG. 7H), laterally extending edges/surfaces 130 of the coupler 112 that at least partly define each of the recesses/holes H engage the end portions 122/122′ preventing, or at least inhibiting, the displacement of the braces 101, 101′ longitudinally away from each other and relative to the coupler 112.

When an assembly having like braces 101, 101′each provided with tabs T′ is tensioned along its length, however, the forced, along a longitudinal axis of the braces, abutment between the edges 130 and the inclined end portions 122′ may cause/force/bias the edges 130 of the coupler 112 to ride/move upwardly relative to the end portions 122′, relatively away from brace 101 (and/or brace 101′), and in particular the central portion(s) C thereof, such that the central portion 118/coupler 112 is displaced relative to/in a direction away from the central portions C/braces 101, 101′ (as generally indicated by arrow 300 in FIG. 7H). Displacement of the coupler 112 relative to one or both the braces 101, 101 may adversely affect the integrity of the interconnection of the braces and the functioning of the assembly 110 when used to brace a building frame.

With reference to FIGS. 7H and 7I, in some examples of the present disclosure, the coupler 112 may be provided with one or more formation/protrusions 132 configured to engage/interact with the diagonally extending/inclined end portion 122′ and prevent, or at least inhibit, relative displacement of the coupler 112 in the direction 300, relative to one or both the braces 101, 101′, when an assembly 110 comprising the braces is tensioned along its length. The coupler 112 comprises a formation (or formations) 132 associated with each recess/hole H.

Each of the example formations 132 shown is in the form of a nose portion 134 that protrudes/extends from and/or at least partly defines the edge 132. The formation 132 protrudes into the recess/hole H. In particular, the formation extends/protrudes downwardly (in a direction downwardly from an upper surface CS3 of the coupler 118 towards the respective brace) and in a direction towards a central region 138 that, in use of the coupler, is located between or at the adjacent ends 101A, 101B of the interconnected braces 101, 101′. The formation 132 defines the (inclined) edge/surface 130 that in use is configured to engage an (inclined) surface 140 of the end portion 122′.

When the connecting elements in the form of respective pockets/recesses/apertures/holes H receive the respective connecting members in the form of the tabs T′ to interconnect the braces, the formations/protrusions 132 may be configured to resiliently flex/deflect when engaged by the end portions 132 of the tabs T′ as the tabs T′ are located in the recesses. In the assembly 110, the formations/protrusions 132 may be resiliently biased and/or abut against the end portions 132 to thereby form an interference fit between the surface/edge 130 of the coupler 112 and the surface 140 of the tab T′. Advantageously, when the assembly is tensioned along its length, the formations/protrusions 132/surface/edge 130 of the coupler 112 will engage, for example, frictionally engage and/or dig/penetrate into the end portion 122′/surface 140′ to inhibit the surface/edge 130 moving, for example sliding, relative to the end portion 122′/surface 140′ in a direction 300 away from the brace 101 (or 101′) and the coupler 112, or a part thereof, being displaced relative to the brace 101.

In another example of the present disclosure (not shown), the or each end portion 122′ may be formed with a recess configured to receive at least part of a respective formation 132 when the connector 112 is coupled to the braces to prevent, or at least inhibit, movement of coupler relative to the brace(s) (in the direction indicated by arrow 300 in FIG. 7H) when the formation 132 engages the recess. Alternatively, the surface/edge 130 of the coupler 112 and/or the surface 140′ of the brace may comprise other surface formations, such as one or more ridges and/or interlocking elements, arranged to similarly prevent, or at least inhibit, movement of coupler relative to the brace(s) in the direction 300.

It will be understood, according to alternative examples of the present disclosure, the tabs may be other shapes/profiles. For example, the tabs T/T′ may have a generally rectangular profile along the longitudinal direction of the brace 101 (or 101′), with the raised portion/surface 120/120′ generally extending in a plane parallel to a plane in which the central portions C (or at least an upper surface thereof), from which the tabs T extend/protrude, extend. Alternatively, the raised portion/surfaces 120/120′ may be a curved/arcuate, such as convex or concave, surface. Alternatively, at least part of the raised portion/surface 120/120′ may be in the form of a substantially inclined plane, that extends longitudinally and laterally, and downwardly and in a direction from the end 101A (or 101B) proximal the respective tab T towards the opposite end 101B distal the respective tab T. Alternatively, the end portion/surface 120/120′ may define a curved/arcuate surface.

By selecting braces 101 of suitable length, from a kit 118 comprising a coupler 112 and braces 101 in differing and/or standard lengths, it may be possible to reduce or avoid wastage otherwise resulting from the brace assembly 110 being longer than necessary and/or to use the kit 118 to form the brace assembly 110 in-situ with a desired or required length that substantially matches that of a span of the framework to be braced thereby. This being said, it is understood that the kit 118 may, in other embodiments, be provided with braces 101 of a single or common length only.

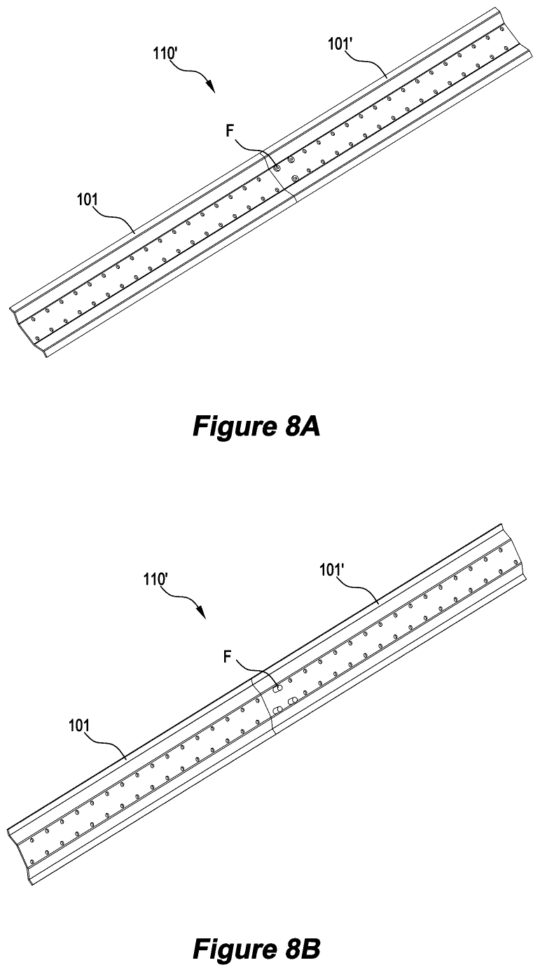

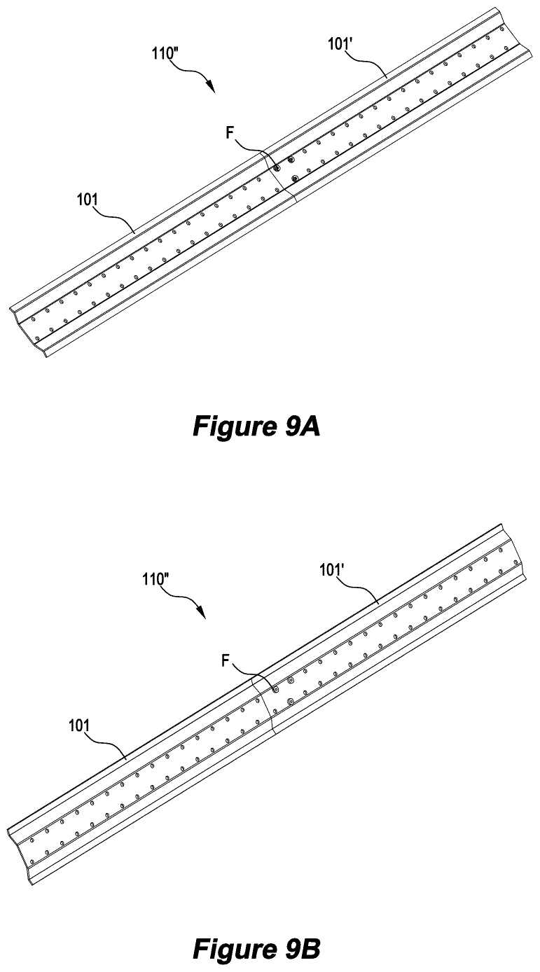

It is also contemplated that, in place of coupler 112, axially aligned braces 101, 101′ may be interlocked together by one or more fasteners F. In particular, as shown in FIGS. 8A and 8B, a brace assembly 110′ is formed by arranging adjacent ends of the braces 101, 101 in an overlapping manner, and inserting screws through aligned receiving formations D of the respective braces 101, 101′. Alternatively, the screws may, instead of being inserted/driven through aligned formations/apertures of the braces 101, 101′, be driven through a portion of the body of one both of the braces 101, 101′ not including and/or spaced from the formation(s). A similar brace assembly 110″ is shown in FIGS. 9A and 9B, where axially aligned braces 101, 101′ are interlocked together in a similar manner using rivets.

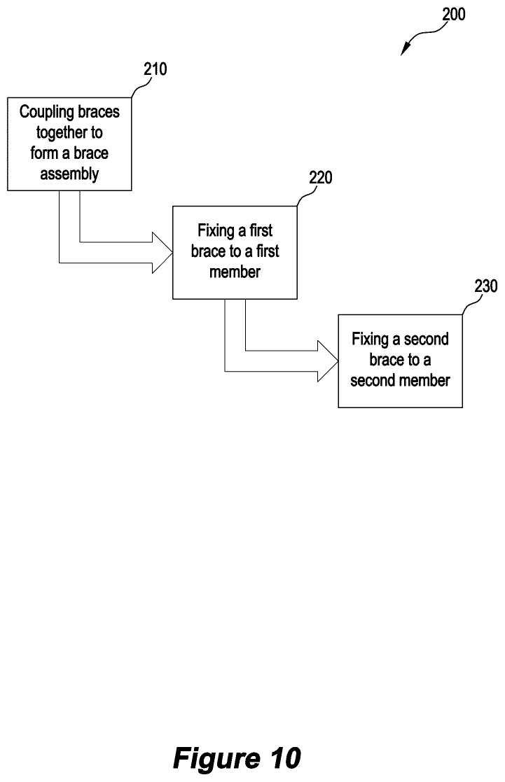

A method 200 of bracing a timber building frame using the brace assembly 110 as described herein will now be described with reference to FIG. 10.

In a coupling step 210, a brace assembly 110 is formed by coupling together respective braces 101 in an end-to-end manner. When complete, the brace assembly 110 will have a length sufficient to span between first and second members of the building framework. During this step, for example, connecting members T of the respective braces 101 may be brought into engagement with the complementary connecting elements H of the coupler 12. The engagement is preferably a “click and lock” engagement that does not require external tools, clips, or the like. It is contemplated that the coupling of adjacent braces 101 to the coupler 112 may include receiving a first side portion S of the brace 101′ into a corresponding hook portion 116 of the coupler 112 and twisting the brace 101′ such that an opposite second side portion S thereof is received with the corresponding, offset, hook portion 116 of the coupler 112. Alternatively, during this step, adjacent braces 101 may be coupled together by arranging respective ends thereof to overlap and then driving fasteners such as screws or rivets through the overlapping portions thereof.

In a first fixing step 220, a first brace 101 disposed at or toward a first end of the brace assembly 110 is fixed or otherwise secured to a first member of the building framework. During this step, the brace 101 may be positioned with respect to the first member such that the central wall C is rested in substantial abutment with the support surface SU of the first member. Fasteners such as nails N may be driven through the formations D within the central wall C of the brace 101 using a hammer or nail driving tool.

In a second or further fixing step 230, a second brace 101′ disposed at or toward an opposite end of the brace assembly 110 is fixed or otherwise secured to a second member of the building framework. During this step, the brace 101′ may be positioned with respect to the second member such that the central wall C′ is rested in substantial abutment with the support surface SU′ of the second member. Fasteners such as nails N may be driven through the formations D′ within the central wall C′ of the brace 101′.

It is understood that the coupling step 210 may (but is not required to) precede one or both of the fixing steps 220, 230, and may be carried out at a ground level before the formed brace assembly 110 is raised upwardly through or otherwise positioned atop the framework. When the splicing together of the brace assembly is carried out at ground level, there is an improved level of safety for installers compared to when splicing occurs at height or otherwise in-situ atop the building framework. It is also understood that the brace assembly 110 may be formed sequentially with additional braces 101 added to meet the required span. For example, with the brace assembly fixed at one end to the first member, additional braces 101 may be added or removed as needed to obtain the required length to extend to the second member in a substantially straight line, avoiding meandering and minimising material wastage. Moreover, any leftover lengths of brace, only having a single connecting end 112A (or 112B) after during assembly a second/the other connecting end 112B (or 112A) has been trimmed therefrom, can be used to start a new brace assembly, further potentially minimising/avoiding material wastage.

It is understood that the brace 101 and method of use 200 thereof may provide fabricators with a roof bracing product, such as bracing apparatus/assembly for roof, wall and/or floor frames, that provides several improvements over previously proposed bracing, particularly when used as a brace for a timber roof assembly.

For example, the brace 101 advantageously does not require manual hammering/fixing while working on heights, with the provision of fastener holes allowing/facilitating the use of nail driving tools to secure to the building frame resulting in a faster process. Further, the “click and lock” coupling mechanism 112 advantageously allows for a plurality of braces 101 to be coupled together to form an assembly 110 having a length to match a required span (for example 6 meters or more), substantially obviating the need to transport braces of such span which may reduce transportation costs. Further, the M shaped profile advantageously does not bend or sag while handling which represents safety improvements when used in-situ at height, whilst also not require flattening when installed to a roof. It is also understood that use of the brace 101, and in particular brace assembly 110 formed therefrom, may result in reduced material wastage as respective lengths of a respective brace 101 can be cut to size as required, with the cut-off portions 101a being used to form a subsequent brace assembly 110′.

It will be clear that the preferred embodiments offer a number of benefits over the brace disclosed in AU2006100777, the content of which is incorporated herein by reference.

Braces/straps according to embodiments disclosed herein comprise, one or more formations therealong in and/or on its surface/the face thereof defining that surface. At least one said formation may, for example comprise a cavity or hole in the surface, and/or be impressed in or into said surface, such that it can receive a tip of a said nail (or possibly an alternative driven fastener, such as a screw) whereby the nail can be driven through the strip/strap and into a framework. At least one said formation or cavity may, for instance, comprise a channel or groove such that it can receive a nail tip at any position therealong, which channel groove may extend lengthways and/or widthways. At least one said formation, alternatively or additionally, may be configured, e.g. in the form of a dimple or crater, such that a nail tip is receivable thereby at a discrete position. At least one said formation, alternatively or additionally, may comprise a rough or roughened (e.g. abraded) surface region whereby a said nail tip received by that formation is precluded from slipping or sliding relative to the formation (e.g. along a said channel or groove which said formation comprises).

In the embodiments described and illustrated (and other embodiments), the formations provide fastener holes, or precursors for such fastener holes, which are defined at set positions along the brace/strap/strip for fixing the strip to a surface of the framework. In some embodiments, blind holes (e.g. defining respective pilots) may be formed at such positions for receiving a tip of the fastener, with fasteners holes then being formed in the strip by the act of the fastener penetrating the brace/strap/strip when driven to fix the brace/assembly to the framework. The fastener holes and/or precursors for such fastener holes may facilitate locating of the fastener/fastener applicator and/or the application/driving of the fastener into the framework.

Braces embodying the present disclosure, including those described above and illustrated, may be made from metal, such as steel and/or other materials (e.g. suitably strong plastics material).

The word “timber” as used herein refers, except where context otherwise requires, to both solid or natural timber and “mass timber”, the latter comprising wood constituents—such as veneers, boards, strands, fibres or particles—and adhesive or other substances or mechanisms holding the wood constituents together, and including laminated timber, such as glulam, laminated veneer, such as laminated veneer lumber (LVL), fibreboard, such as medium-density fibreboard and high-density fibreboard, particleboard and oriented strand board (OSF).

While various embodiments of the present disclosure have been described above, it should be understood that they have been presented by way of example only, and not by way of limitation. It will be apparent to a person skilled in the relevant art that various changes in form and detail can be made therein without departing from the spirit and scope of the present disclosure. Thus, the present disclosure should not be limited by any of the above described exemplary embodiments.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A brace configured to be fixed to members of a building frame in an orientation, the brace comprising:
a strip positionable against members of the frame in the orientation, the strip including a central wall portion and opposed lateral side wall portions,
the central wall portion between the opposed lateral side wall portions, and
the opposed lateral side wall portions each laterally inwardly inclined such that the strip has an angled cross-sectional configuration.

2. The brace of claim 1, which includes a first end having a connecting member that enables the brace to be connected to another brace in an end-to-end manner.

3. The brace of claim 2, wherein the connecting member is part of the central wall portion.

4. The brace of claim 1, which includes a first end having a plurality of connecting members that each enable the brace to be connected to another brace in an end-to-end manner.

5. The brace of claim 1, which includes a first end having a first connecting member that enables the brace to be connected to a second brace in a first end-to-end manner, and a second end having a second connecting member that enables the brace to be connected to a third brace in a second end-to-end manner.

6. The brace of claim 1, which includes spaced-apart formations positioned and configured to receive driven fasteners that fix the brace to the members.

7. The brace of claim 6, wherein the formations are positioned in a staggered arrangement.

8. The brace of claim 1, wherein the opposed lateral side wall portions each include spaced-apart formations positioned and configured to receive driven fasteners that fix the brace to the members.

9. The brace of claim 8, wherein the central wall portion is configured to abut at surfaces of the members such that the central wall portion is braced by the surfaces against deformation when the driven fasteners are applied to fix the brace to the members.

10. A brace configured to be fixed to members of a building frame in an orientation, the brace comprising:
a strip positionable against members of the frame in the orientation, the strip including a central wall portion and opposed lateral side wall portions,
the central wall portion between the opposed lateral side wall portions,
the opposed lateral side wall portions each laterally inwardly inclined such that the strip has an angled cross-sectional configuration,
the central wall portion including a first end having a first connecting member that enables the brace to be connected to a second brace in a first end-to-end manner, and a second end having a second connecting member that enables the brace to be connected to a third brace in a second end-to-end manner, and
the opposed lateral side wall portions each include spaced-apart formations positioned and configured to receive driven fasteners that fix the brace to the members.

11. The brace of claim 10, wherein the central wall portion is configured to abut at surfaces of the members such that the central wall portion is braced by the surfaces against deformation when the driven fasteners are applied to fix the brace to the members.
